(19) United States
(12) Patent Application Publication
(10) Pub. No.: US 2024/0217102 A1
(43) Pub. Date: Jul. 4, 2024

(54) METHOD FOR ACCURATELY POSITIONING A ROBOTIC ARM AT A TARGET POSITION IN AN AUTOMATED SAMPLE HANDLING DEVICE AND SUCH A DEVICE

(71) Applicant: TECAN TRADING AG, Männedorf (CH)

(72) Inventors: Volfgang VILAJ, Uetikon am See (CH); Luca FREI, Rapperswil (CH); Simon STRASSEN, Männedorf (CH); Philipp OTT, Steg (CH)

(21) Appl. No.: 18/390,607

(22) Filed: Dec. 20, 2023

(30) Foreign Application Priority Data
Dec. 29, 2022 (EP) 22 217 185.2

(51) Int. Cl. B25J 9/16; B25J 11/00; B25J 13/08

(52) U.S. Cl. CPC B25J 9/1664; B25J 9/1697; B25J 11/005; B25J 13/087; B25J 13/089

(57) ABSTRACT

A method accurately positions a robotic manipulator at a target position of a target object in an automated sample handling device. An optical reference object is detectable by imaging located at a first position at a worksurface and a capacitive reference object is located at a second position at the worksurface. A position of the robotic manipulator relative to the second position is detectable by measurements of the electrical impedance/capacitance between the capacitive reference object and the robotic manipulator acting as a measuring probe. An image is then taken of the first reference object together with the target object to determine the target position and a current position of the robotic manipulator is determined based on electrical impedance/capacitance measurements taken at different locations of the capacitive reference object. The robotic manipulator is then moved from the determined current position to the determined target position.

### CROSS-REFERENCE TO RELATED APPLICATIONS

This patent application claims the benefit and priority of European Patent Application No. 22 217 185.2, filed on Dec. 29, 2022, the disclosure of which is incorporated by reference herein in its entirety as part of the present disclosure.

### TECHNICAL FIELD

The present invention is related to the technical field of automated sample handling/processing systems and in particular pertains to methods for accurately positioning a robotic arm/manipulator or a part attached thereto, e.g., a pipette tip or a nozzle, in particular an opening thereof, or a gripper, in particular a finger/pin thereof, at a desired target location as well as sample handling devices capable to performing such methods.

### BACKGROUND OF THE INVENTION

When large quantities of samples must be examined in medical, chemical, analytical or pharmaceutical laboratories, automated laboratory systems are typically used today to enable rapid and reliable processing of each individual sample. Usually, one or more robotic manipulators/arms, such as a sample handling arm, are employed for the fully automatic operation of such laboratory systems. These robotic arms are specialized to deal with sample containers, such as sample tubes, microplates or microfluidic chips, in which the samples are located. Such sample processing systems comprise in particular pipettors both for aspirating and dispensing liquids or dispensers for dispensing liquids.

In view of the often very small dimensions of the sample containers, in particular of the tiny cavities (so-called “wells”) in microplates having a large number, e.g., 96, 384 or 1536, cavities/wells, particularly accurate positioning by the robot arm, for example, of the pipette tip or nozzle, is necessary. Mechanical tolerances limit the accuracy with which the robot arm, e.g., the pipette tip or nozzle or gripper arranged thereon, can be positioned. It is therefore often necessary upon start-up of the robot arm to move it to a specific reference position within the sample handling system for the purpose of position calibration. This can be carried out manually, for example, by the robot arm being guided by a person to a specific point. Alternatively, it is possible to determine the reference position automatically, by the robot registering based on end switches or force measurements that it touches, for example, an end stop at the reference position.

Problems that arise regarding the precise positioning of the robot arm or a part attached thereto, e.g., a pipette tip or a nozzle or a gripper or finger(s) of the gripper, is that because of movement tolerances, it may be necessary to perform a position calibration periodically during the operation of the sample handling system.

Moreover, when disposable tips are employed, the used tip is periodically removed from the pipette tube and replaced with a new one, whereby due to manufacturing tolerances as well as mounting tolerances the position of the opening of the new pipette tip or nozzle will likely deviate from that of the previously attached tip. Likewise, when different exchangeable grippers are employed, e.g., for different purposes, the exact position of a finger of a newly mounted gripper is not exactly known, e.g., due to mounting tolerances.

Therefore, there exists a need in automatic sample handling systems for means which enable a simple and therefore cost-effective as well as reliable and accurate position determination or calibration. Such means should also enable the position to be set or calibrated precisely (periodically) during the operation of the sample handling system.

### SUMMARY OF THE INVENTION

It is an object of the present invention to provide a method for accurately positioning a robotic manipulator or a part attached thereto, e.g., a pipette tip, in particular a disposable tip, or a nozzle or a gripper, at a target position of a target object in an automated sample handling device. This object is achieved according to the present invention by the method defined in claim 1.

It is a further object of the present invention to specify uses of the proposed method for accurate positioning. This object is achieved according to the invention by the uses given in claim 16.

Furthermore, it is an object of the present invention to provide an automated sample handling device, which is capable of accurately positioning a robotic manipulator or a part attached thereto at a target position of a target object. This object is achieved according to the invention by the automated sample handling device defined in claim 17.

Specific embodiment variants according to the invention are specified in the dependent claims.

Note that in the following features in parentheses are to be regarded as exemplary/optional.

According to a first aspect of the present invention, the following method for accurately positioning a robotic manipulator or a part attached thereto, e.g., a pipette tip, in particular a disposable tip, or a nozzle (for aspirating, dispensing or extracting samples) or a gripper, at a target position of a target object in an automated sample handling device is proposed, comprising the steps of:
providing a worksurface, e.g., a worktable, for placement of at least one container and/or container carrier, wherein the worksurface extends in a horizontal x and a horizontal y direction;
providing a robotic manipulator, such as a sample handling arm, in particular to which the part is attached, wherein the robotic manipulator is moveable in the x direction, the y direction and a vertical z direction, and wherein at least a part of the robotic manipulator or of the part attached thereto forms a first electrode of a measuring capacitor and thus acts as a measuring probe;
providing an optical, first reference object or mark (centred) at a (known) first position at or on the worksurface or container carrier, wherein the first reference object is detectable by means of imaging;
providing a capacitive, second reference object (centred) at a (known) second position at or on the worksurface or container carrier, wherein the second reference object forms a second electrode of the measuring capacitor, and wherein a position of the robotic manipulator or of the part attached thereto relative to the second position is detectable by means of electrical impedance measurements, in particular electrical capacitance measurements, more particularly absolute capacitance measurements;
placing a container, such as a microplate or a microfluidic chip, or a sample carrier, such as a Petri dish or a substrate, in particular a glass slide, containing or bearing or intended to receive one or more samples, on the worksurface or container carrier, wherein the container or sample carrier features the target object;
capturing at least one image with an imaging device, such as a camera, wherein the at least one image comprises the first reference object and the target object, and wherein the imaging device in particular is mounted on the robotic manipulator;
detecting an imaged first position of the first reference object and an imaged target position of the target object based on the at least one image;
determining a target position based on the first position, the imaged first position and the imaged target position, in particular by taking into account an imaging function of the imaging device, in particular optical properties of one or more lenses of the imaging device, more particularly by rectifying or dewarping optical distortion of the imaging device;
moving the robotic manipulator or the part attached thereto, i.e., the measuring probe, to different locations of the second reference object in a vicinity of the second position and performing an electrical impedance measurement of the measuring capacitor, in particular an electrical capacitance measurement, more particularly an absolute capacitance measurement, at the different locations of the second reference object;
determining a current position of the robotic manipulator or the part attached thereto based on the electrical impedance measurements, in particular electrical capacitance measurements, more particularly absolute capacitance measurements taken at the different locations of the second reference object;
moving the robotic manipulator or the part attached thereto from the current position to the target position.

The container carrier, such as a tablet or tray, is adapted to receive/accommodate one or more sample containers or sample carriers such as sample tubes, sample tube racks, microplates, microfluidic chips, glass slides, Petri dishes, etc. A container carrier may be placed on the worksurface or worktable and may itself form a worksurface. A container carrier may be mounted on a motorised transport unit so that it can be moved on the worksurface or worktable. Moreover, reference objects may be located at positions on the container carrier.

In an embodiment of the method the part attached to the robotic manipulator is at least one of:
a pipette with a pipette tip, in particular a disposable tip, or a nozzle, wherein in particular an opening of the pipette tip or nozzle is to be positioned accurately;
a gripper, in particular with a finger or pin, wherein in particular an end of the gripper, more particularly of the finger or pin, is to be positioned accurately.

In a further embodiment the method further comprises aspirating, dispensing or extracting a sample or material to or from the container or carrier through the opening of the pipette tip, in particular the disposable tip, or of the nozzle.

In a further embodiment of the method the second reference object has at least one edge, at which, during a movement of the measuring probe, e.g., of the pipette tip or of the nozzle, the impedance, in particular the capacitance, of the measuring capacitor changes, and at which in particular a change of a conductivity or dielectric constant takes place.

In a further embodiment of the method the second reference object comprises at least one material transition, which, during movement of the measuring probe, e.g., of the pipette tip or of the nozzle, causes a change of the impedance, in particular the capacitance, of the measuring capacitor, and at which in particular a change of a conductivity or dielectric constant takes place.

In a further embodiment of the method the second reference object has at least one recess, depression cut-out or opening, such as a hole, through-hole, slot, or groove, which, during movement of the measuring probe, e.g., of the pipette tip or of the nozzle, causes a change of the impedance, in particular of the capacitance, of the measuring capacitor.

In a further embodiment of the method the recess, depression, cut-out or opening is triangular or trapezoidal, and wherein the second reference object in particular has two identical triangular or trapezoidal recesses, depressions, cut-outs or openings, which are arranged in particular rotated by 180° in relation to one another, and wherein the measuring probe, e.g., the pipette tip or the nozzle, traverses both recesses, depressions, cut-outs or openings during the measurements.

In a further embodiment of the method the second reference object comprises two slots (crossing/)intersecting each other, in particular two perpendicular slots, in particular (crossing/)intersecting each other in their respective midpoint.

In a further embodiment of the method the first (and/or third and/or fourth; cf. below) reference object has a distinct shape and/or structure and/or colour, wherein the distinct shape or structure in particular has a (centre) point located at the first position, and wherein the distinct colour in particular stands out from or is in (strong) contrast to the worksurface or container carrier, in particular allowing identification(/extraction) of the first (and/or third and/or fourth; cf. below) reference object from the at least one image by means of colour filtering.

In a further embodiment of the method the first (and/or third and/or fourth; cf. below) reference object comprises a luminescent material, in particular to achieve a fluorescent or phosphorescent effect (when stimulated with corresponding light).

In a further embodiment of the method a light source, in particular an ultraviolet (UV) or (mid-)infrared (IR/MIR) light source, is employed for illuminating the first (and/or third and/or fourth; cf. below) reference object.

In a further embodiment of the method the first reference object comprises crosshairs and in particular a circle centred at an intersection of the crosshairs, the intersection in particular being located at the first position.

In a further embodiment of the method the first and second reference objects are co-located, in particular wherein the second position is the same as the first position, more particularly wherein the crosshairs are centred between the pairs of triangles.

In a further embodiment of the method an optically visible shape or structure of the second reference object acts as the first reference object.

In a further embodiment of the method a third and optionally a fourth reference object or mark (centred) at a (known) third position and fourth position, respectively, are provided at or on the worksurface or container carrier, wherein the third and fourth reference object is detectable by means of imaging.

In a further embodiment of the method the first and third and optionally the fourth reference objects or marks are used to calculate a conversion factor from pixels on the at least one image to millimetres on the worktable, and in particular to calculate a rotation angle of the imaging device relative to the x (or y) direction, and in particular also to rectify or dewarp optical distortion of the imaging device.

In a further embodiment of the method the first, third and fourth reference objects are level with the target object, in particular a vertical z position of the reference objects and the target object is the same, in particular the first, third and fourth reference objects and the target object are in the (same) focal plane of the imaging device.

In this way an angular error is minimised. Furthermore, this allows to use fixed focus lenses and to simplify the vector calculations from 3D space to 2D worktable coordinates. The position determination/correction is then valid for the defined z-level/plane.

In a further embodiment of the method as part of detecting the imaged first position of the first reference object a cross-correlation, in particular a normalised cross-correlation, is performed using a template corresponding to the first reference object.

According to a second aspect of the present invention, the following uses of the method proposed above are specified:
loading microfluidic chips using a pipette tip or a nozzle;
integrating targets such as biological samples, e.g., tissue sections, with non-teachable positions in a sample or liquid handling platform for automating integrated workflows, e.g., preparation of samples for subsequent protein analysis by means of matrix-assisted laser-desorption-ionisation time-of-flight mass spectrometry (MALDI-TOF MS);
positioning a nozzle precisely in an area of interest on a tissue slice or a bacteria culture, in particular for so-called colony picking of bacteria cultures or nucleic acid extraction from tissue slices;
positioning a nozzle precisely when 3D printing a structure by dispensing 3D printing material with the nozzle, for instance for tissue extraction in an area of interest, in particular by 3D printing, e.g., with paraffin, a boundary around the area of interest to be extracted;
positioning a gripper of a robotic manipulator, in particular one or more fingers of the gripper, precisely at a piece of labware, e.g., a sample container, so that the gripper can accurately take hold of the piece of labware.

In the proposed use employing 3D printing, for instance a lysis buffer is filled/dispensed into the area of interest confined by the previously 3D printed boundary, and after lysis the lysate is aspirated with a pipette tip.

According to a third aspect of the present invention, the following automated sample handling device capable of accurately positioning a robotic manipulator or a part attached thereto, e.g., a pipette tip, in particular a disposable tip, or a nozzle (for aspirating, dispensing or extracting samples) or a gripper, at a target position of a target object is proposed, comprising:
a worksurface, e.g., a worktable, for placement of at least one container, such as a microplate or a microfluidic chip, or sample carrier, such as a Petri dish or a substrate (in particular a glass slide), adapted to contain, bear or receive one or more samples, and/or of at least one container carrier, wherein the worksurface extends in a horizontal x and a horizontal y direction, and wherein the container or sample features the target object;
a robotic manipulator, such as a sample handling arm, in particular to which the part, e.g., the pipette tip or the nozzle or the gripper, is attached, wherein the robotic manipulator is moveable in the x direction, the y direction and a vertical z direction, and wherein at least a part of the robotic manipulator or of the part attached thereto, e.g., of the pipette tip or of the nozzle of the gripper, forms a first electrode of a measuring capacitor and thus adapted to act as a measuring probe;
an optical, first reference object or mark (centred) at a (known) first position at or on the worksurface or container carrier, wherein the first reference object is detectable by means of imaging;
a capacitive, second reference object (centred) at a (known) second position at or on the worksurface or container carrier, wherein the second reference object forms a second electrode of the measuring capacitor, and wherein a position of the robotic manipulator or of the part attached thereto, e.g., of the pipette tip or of the nozzle or of the gripper, relative to the second position is detectable by means of electrical impedance measurements, in particular electrical capacitance measurements, more particularly absolute capacitance measurements;
an imaging device, such as a camera, adapted to capture at least one image comprising the first reference object and the target object and thus acquire an imaged first position and an imaged target position, wherein the imaging device is in particular mounted on the robotic manipulator;
a measuring unit, to which the measuring probe and the second reference object are operationally connected, adapted to measure an impedance, in particular a capacitance, more particularly an absolute capacitance of the measuring capacitor;
a control unit adapted to:
determine a target position based on the first position, the imaged first position and the imaged target position, in particular by taking into account an imaging function of the imaging device, in particular optical properties of one or more lenses of the imaging device, more particularly by rectifying or dewarping optical distortion of the imaging device;
actuate the robotic manipulator such that the measuring probe is moved to different locations of the second reference object in a vicinity of the second position;
trigger the measuring unit to perform electrical impedance measurements, in particular electrical capacitance measurements, more particularly absolute capacitance measurements, at the different locations of the second reference object;
determine a current position of the measuring probe based on the electrical impedance measurements, in particular electrical capacitance measurements, more particularly absolute capacitance measurements taken at the different locations of the second reference object;
move the robotic manipulator or the part attached thereto, e.g., the pipette tip or the nozzle or the gripper, from the current position to the target position.

In an embodiment of the device the part attached to the robotic manipulator is at least one of:
a pipette with a pipette tip, in particular a disposable tip, or a nozzle, wherein in particular an opening of the pipette tip or nozzle is to be positioned accurately;
a gripper, in particular with a finger or pin, wherein in particular an end of the gripper, more particularly of the finger or pin, is to be positioned accurately.

In a further embodiment the device the control unit is further adapted to actuate the pipette tip or nozzle to aspirate, dispense or extract a sample or material to or from the container or carrier through the opening of the pipette tip, in particular the disposable tip, or of the nozzle.

In a further embodiment of the device the second reference object has at least one edge, at which, during a movement of the measuring probe, e.g., of the pipette tip or of the nozzle or of the gripper, the impedance, in particular the capacitance, of the measuring capacitor changes, and at which in particular a change of a conductivity or dielectric constant takes place.

In a further embodiment of the device the second reference object comprises at least one material transition, which, during movement of the measuring probe, e.g., of the pipette tip or of the nozzle or of the gripper, causes a change of the impedance, in particular the capacitance, of the measuring capacitor, and at which in particular a change of a conductivity or dielectric constant takes place.

In a further embodiment of the device the second reference object has at least one recess, depression cut-out or opening, such as a hole, through-hole, slot, or groove, which, during movement of the measuring probe, e.g., of the pipette tip or of the nozzle or of the gripper, causes a change of the impedance, in particular of the capacitance, of the measuring capacitor.

In a further embodiment of the device the recess, depression, cut-out or opening is triangular or trapezoidal, and wherein the second reference object in particular has two identical triangular or trapezoidal recesses, depressions, cut-outs or openings, which are arranged in particular rotated by 180° in relation to one another, and wherein the measuring probe, e.g., the pipette tip or the nozzle or the gripper, traverses both recesses, depressions, cut-outs or openings during the measurements.

In a further embodiment of the device the second reference object comprises two slots (crossing/)intersecting each other, in particular two perpendicular slots, in particular (crossing/)intersecting each other in their respective midpoint.

In a further embodiment of the device the first reference object has a distinct shape and/or structure and/or colour, wherein the distinct shape or structure in particular has a (centre) point located at the first position, and wherein the distinct colour in particular stands out from or is in (strong) contrast to the worksurface or container carrier, in particular allowing identification(/extraction) of the first reference object from the at least one image by means of colour filtering.

In a further embodiment of the device the first (and/or third and/or fourth; cf. below) reference object comprises a luminescent material, in particular to achieve a fluorescent or phosphorescent effect (when stimulated with corresponding light).

In a further embodiment of the device a light source, in particular an ultraviolet (UV) or (mid-)infrared (IR/MIR) light source, is employed for illuminating the first (and/or third and/or fourth; cf. below) reference object.

In a further embodiment of the device the first reference object comprises crosshairs and in particular a circle centred at an intersection of the crosshairs, the intersection in particular being located at the first position.

In a further embodiment of the device the first and second reference objects are co-located, in particular wherein the second position is the same as the first position, more particularly wherein the crosshairs are centred between the pairs of triangles.

In a further embodiment of the device an optically visible shape or structure of the second reference object acts as the first reference object.

In a further embodiment of the device a third and optionally a fourth reference object or mark (centred) at a (known) third position and fourth position, respectively, are provided at or on the worksurface or container carrier, wherein the third and fourth reference object is detectable by means of imaging.

In a further embodiment of the device the first and third and optionally the fourth reference objects or marks are used to calculate a conversion factor from pixels on the at least one image to millimetres on the worktable, and in particular to calculate a rotation angle of the imaging device relative to the x direction, and in particular also to rectify or dewarp optical distortion of the imaging device.

In a further embodiment of the device the first, third and fourth reference objects are level with the target object, in particular a vertical z position of the reference objects and the target object is the same, in particular the first, third and fourth reference objects and the target object are in the (same) focal plane of the imaging device.

In this way an angular error is minimised. Furthermore, this allows to use fixed focus lenses and to simplify the vector calculations from 3D space to 2D worktable coordinates. The position determination/correction is then valid for the defined z-level/plane.

In a further embodiment the device comprises image processing means adapted to perform a cross-correlation, in particular a normalised cross-correlation, using a template corresponding to the first reference object as part of detecting the imaged first position of the first reference object.

It is specifically pointed out that combinations of the embodiments mentioned above can result in even further, more specific embodiments.

It is also to be noted that certain features/elements of the embodiments mentioned above can be considered as stand-alone inventions, which can for instance be employed independently in other possible methods and devices.

### BRIEF DESCRIPTION OF THE DRAWINGS

The present invention is further explained below by means of non-limiting specific embodiments and with reference to the accompanying drawings, which show the following:

FIG. 1 shows a top view of a worktable of a sample handling system/device having a robot arm, wherein different pieces of labware (containers & carriers) are placed on the worktable;

FIG. 2 shows a typical workflow according to the proposed method for accurately positioning an opening of a pipette tip or nozzle;

FIG. 3 shows in part a) a cross-section of a worktable having a capacitive reference object in the form of a recess, and in part b) idealised capacitance curve of the measuring capacitor as a function of the x coordinate of a measuring probe (pipette tip) for the capacitive reference object of part a);

FIG. 4 shows a top view of a worktable having a capacitive reference object in the form of two triangular recesses arranged next to each other;

FIG. 5A shows a perspective view of a worktable having a capacitive reference object in the form of two triangular recesses arranged next to each other together with a measuring probe (pipette tip),

FIG. 5B shows measured capacitance of the measuring capacitor along the path of the measuring probe for the capacitive reference object of FIG. 5A;

FIG. 6 shows an exemplary plot of a 2D cross-correlation for determining the location of three optical reference objects; and

FIG. 7 shows a perspective view of a robot arm with a gripper, whereby the two fingers of the gripper are to be precisely positioned to carefully take hold of a sample tube arranged in a carrier.

In the figures, like reference signs refer to like parts/elements.

### DETAILED DESCRIPTION OF THE INVENTION

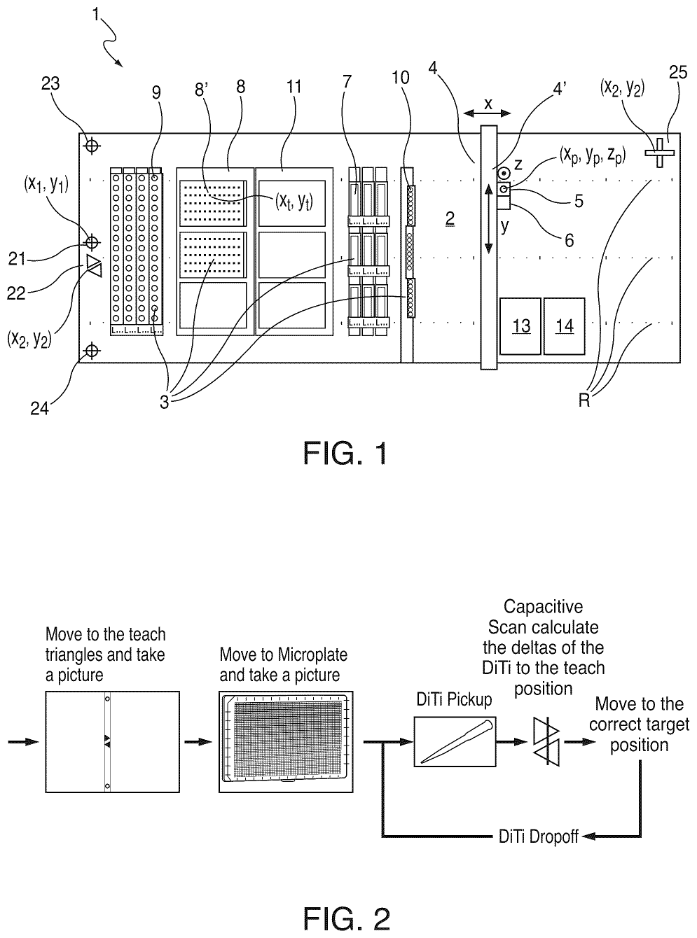

FIG. 1 shows a top view of a worktable 2 or worksurface of an exemplary automatic sample handling system/device 1 with a pipetting robot (arm) 4. Movements of the pipetting robot (arm) 4 are driven by motors. The pipetting robot (arm) 4 comprises a beam 4′ moveable along the x direction of the worktable 2, the beam 4′ being located at a fixed height above and spanning across the worktable 2 in the y direction (perpendicular to the x direction). A vertical z rod is attached to the beam 4′, the z rod being movable along the beam 4′ and therewith across the worktable 2 in the y direction. A pipette 5 with a (disposable) pipette tip 5′ for aspirating and/or dispensing liquid samples (or an extractor/dispenser with a nozzle for extracting and/or depositing sample material) is mounted to the z rod. The pipette 5 can be moved up and down the z rod in the z direction (perpendicular to the x/y plane) so that the pipette 5 and the pipette tip 5′ can be lowered down towards or raised up from the worktable 2. The pipette 5 can be fluidically connected, e.g., via a flexible tube, with an activatable pump. A liquid (e.g., system liquid) or a gas (e.g., air) or a combination of both (e.g., a system liquid with an “air gap”) may be present between the conveying element of the pump (e.g., a plunger) and the pipette 5 or rather its pipette tip by which a liquid sample can be aspirated or dispensed. A variety of different containers 3 are shown on the worktable 2, such as sample tubes 9, e.g., arranged in so-called “racks”, or microplates 8, e.g., having 24, 96, 384 or 1536 cavities/wells 8′, or glass slides 7 (or alternatively Petri dishes) or microfluidic chips 10 into which samples are to be dispensed/deposited or from which samples are to be aspirated/extracted. Furthermore, six (container) carriers (or tablets) 11 are also illustrated in FIG. 1 for carrying/holding microplates 8. Moreover, the sample handling device 1 comprises a control unit 14 with which the pipetting robot 4 (i.e., the drives and pump) is controlled. A control program executed by the control unit 14 enables the pipetting robot 4 to position the pipette 5 at a specific location on the worktable 2 and perform certain actions/functions there using the pipette tip 5′.

Before moving the pipette 5 the sample handling device 1 must know the position (xₚ, yₚ) of the pipette 5 as well as the target position (xₜ, yₜ) of the target object, e.g., a specific cavity/well 8′ in the microplate 8. To determine the position (xₜ, yₜ) of the target object 8′, the sample handling device 1 is equipped with a camera 6 (or any alternative imaging device, such as a LIDAR “light detection and ranging” sensor). The camera 6 is preferably attached to the beam 4′, i.e., at a fixed height above the worktable 2. The camera 6 may be moveable along the beam 4′, either separately or together with the z rod. Alternatively, the camera 6 may be fixedly attached to the beam 4′, for instance in the middle of the beam 4′ (e.g., at a centre of the y axis of the worktable 2). An optical, first reference object 21 or mark is provided centred at a first (reference) position (x₁, y₁) at or on the worktable 2. The first reference object 21 is detectable by means of imaging with the camera 6. In the example of FIG. 1 a crosshair is used as the first reference object 21. One or more images of the worktable 2, or at least of the first reference object 21 and of the target object 8′ are taken. The target position (xₜ, yₜ) can be identified manually by an operator of the sample handling device 1 on the corresponding image, but can also be detected automatically by the sample handling device 1 itself, for instance based on an appropriate optical (reference) marking (e.g., a red dot), which is possibly offset by a known distance from the actual target position, by means of image processing. Alternatively, a characteristic feature of the target object could be automatically identified again based on image processing. Once the first reference object and the target have been identified on the image(s) the actual target position (xₜ, yₜ) can be determined based on the location of the target object 8′ in the corresponding image, i.e., the imaged target position (xₜ′, yₜ′), the imaged first position (x₁′, y₁′) of the first reference object 21 in the corresponding image and the known first position (x₁, y₁). In order to determine the actual target position (xₜ, yₜ) from the image(s) an imaging function of the camera 6 is taken into account, in particular optical properties of the lens(es) of the camera 6 are taken into account, in order to rectify or dewarp any optical distortion caused by the camera 6.

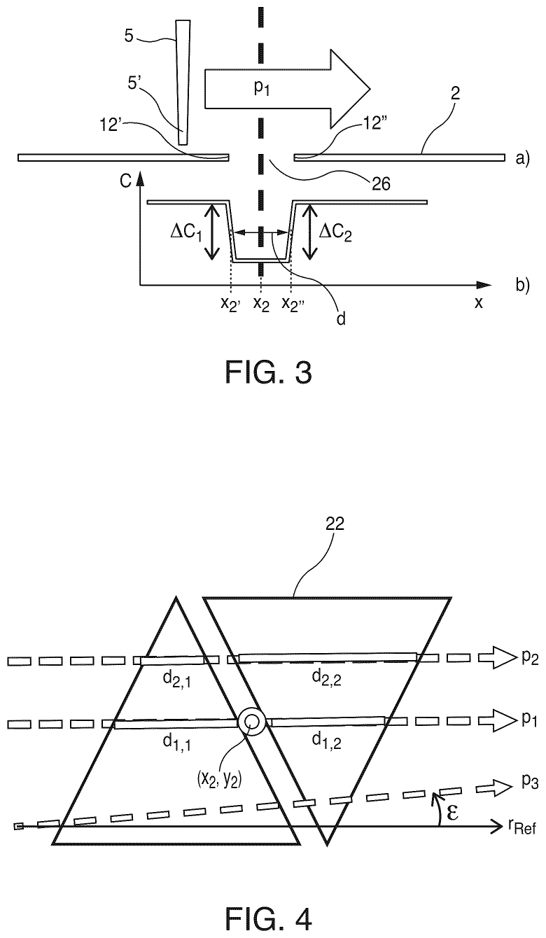

As mentioned above, the pipette 5 is attached to the z rod and a (disposable) pipette tip 5′ is mounted on the pipette 5. Due to mechanical manufacturing tolerances of the pipette tip 5′, mounting inaccuracies of the pipette tip 5′ on the pipette 5 as well as tolerances of the drive system, the position of the opening of the pipette tip 5′ is not exactly known, especially after replacing the (disposable) pipette tip 5′ with another pipette tip 5′. The position of the opening of the pipette tip 5′ can be determined by means of electrical impedance measurements, in particular electrical capacitance measurements, more particularly absolute capacitance measurements. For this purpose, a capacitive, second reference object 22 is provided centred at a second position (x₂, y₂) at or on the worktable 2, wherein the second reference object 22 forms a second electrode of the measuring capacitor, and wherein at least a part of the pipette tip 5 (or of the nozzle) forms a first electrode of a measuring capacitor. The opening of the pipette tip 5′ (or of the nozzle) is then moved to different locations of the second reference object 22 in a vicinity of the second reference position (x₂, y₂) by the pipetting robot 4 and electrical impedance measurements of the measuring capacitor, in particular electrical capacitance measurements, more particularly absolute capacitance measurements, are performed at the different locations of the second reference object 22. The current position (xₚ, yₚ) (and optionally also the vertical coordinate zₚ) of the opening of the pipette tip 5′ or of the nozzle is then determined based on the electrical impedance/(absolute) capacitance measurements taken at the different locations of the second reference object 22. As can be seen in FIG. 1 two triangular recesses/holes are used as capacitive, second reference object 22. Thereby, the worktable 2 containing these two triangular recesses/holes or a separate part containing them is connected to an impedance/capacitance measuring unit 13 together with the measuring probe in the form of the pipette 5 or pipette tip 5′. The measurements will be explained in more detail in conjunction with FIGS. 3-5. The first and second reference objects 21 & 22 can be collocated as shown in FIG. 1 on the left side. The first reference position (x₁, y₁) may even coincide with the second reference position (x₂, y₂). The second reference object 25 can however also be distant from the first reference object 21. The alternative second reference object 25 shown in FIG. 1 on the right side is formed by two slots centrally intersecting each other.

As shown in FIG. 1 on the left side, a third and fourth (optical) reference object 23 & 24 or mark centred at a third position and fourth position, respectively, are provided at or on the worktable 2. Like the first reference object 21, the further two reference objects 23 & 24 take on the form of crosshairs. They are located at the top and bottom left corners of the worktable 2, and all three crosshairs 21, 23 & 24 are arranged on a straight line in the example shown in FIG. 1. They are used to calculate a conversion factor from pixels on the image(s) to millimetres (physical units of length or actual coordinates) on the worktable 2. In particular they are used to calculate a rotation angle of the camera 6 (e.g., an axis of the camera 6 perpendicular to the worktable 2) relative to the x (or y) direction/axis. This information is then employed to rectify a misorientation of the camera 6 as well as to dewarp optical distortions caused by the camera 6. Dewarping of optical distortions caused by the camera 6 can be facilitated (and improved) by using a large number of optical reference points or a grid of lines applied on the worktable 2. These can for instance also be projected onto the worktable by an appropriate light source. Three rows R of optical reference points are illustrated on the worktable shown in FIG. 1.

The first, third and fourth reference objects 21, 23 & 24 are preferably level with the target object 8′, i.e., all at the same vertical z position, so that the first, third and fourth reference objects 21, 23 & 24 and the target object 8′ are all located within the same focal plane of the camera 6, at least approximately, so that they are all in focus at the same time. This allows to use fixed focus lenses and to simplify the vector calculations from 3D space to 2D worktable coordinates. The position determination/correction is then valid for the defined z-level/plane. In this way, also an angular error is minimised.

FIG. 2. schematically illustrates a typical, exemplary workflow according to the proposed method of the invention for accurately positioning an opening of a pipette tip 5′ or nozzle. First a picture/image is taken by the camera 6 of the optical reference objects 21, 23 & 24. From this image the position of the camera 6 and therewith the position of the z rod (as well as the pipette 5 attached to the z rod) relative to the references 21, 23 & 24 (i.e., to the position/coordinates (x₁, y₁) of the first reference 21) can be determined. Then a second image is taken of the microplate 8 with its many cavities/wells 8′. Subsequently, the target position (xₜ, yₜ) of a desired one of the cavities/wells 8′, e.g., the one in the top left corner, is determined a described above taking into account the movement (in x and y direction) of the camera 6 between taking the first and second image (whereby the position of the camera 6 relative to the target position (xₜ, yₜ) can be determined from the second image). Subsequently, the pipetting robot 4 picks up a fresh disposable pipette tip 5′ and then performs the impedance/capacitance measurements as described above when moving the pipette tip 5′ across the capacitive, second reference object 22, i.e., the two triangles located next to each other. In the case shown in FIG. 2 the two triangles (i.e., the capacitive reference object 22) also acts as at least one of the optical reference objects 21, 23 & 24. Details regarding the measurements will be given in more detail below in the text regarding FIGS. 3-5. The pipette is then moved to the first target position, where for instance a liquid sample is aspirated. Once the aspirated sample has been dispensed, the used disposable tip is dropped off, a new disposable tip is picked up and the procedure to determine the exact position of the opening of the new disposable tip is performed. The pipette is then moved to the next target position, e.g., the second cavity/well 8′ in the top row, where again a liquid sample is aspirated. This loop is repeated until liquid samples have been aspirated from all the cavities/wells 8′ of the microplate 8.

FIG. 3a) shows a cross section of a worktable 2 having a recess 26 in the form of a round hole as a capacitive, second reference object. The measuring probe in the form of the pipette tip 5′, which forms the measuring capacitor here together with the worktable 2, is first lowered vertically (i.e., in the z direction) by the pipetting robot 4 until it is located just above the worktable 2 (e.g., at a distance of less than 1 mm). To determine this distance, the capacitance of the measuring capacitor is continuously measured using the measuring unit 13 during the movement of the pipette tip 5′, until it reaches a specific value, which is characteristic for the desired distance of the pipette tip 5′ from the worksurface 2. The pipette tip 5′ is then moved along a horizontal path p₁ (i.e., in the x/y direction) over the worktable 2, which leads over the hole 26. By way of continuous measurement of the capacitance C of the measuring capacitor it is possible to detect the edge 12 of the hole 26, which manifests as a sudden decrease (ΔC₁) of the capacitance C, as is shown in the measured curve of the capacitance C as a function of the x position in FIG. 3b). After the pipette tip 5′ has traversed the hole 26, the second edge 12′ of the hole 26 is indicated by a sudden increase (ΔC₂) of the capacitance C. The measuring unit 13 can thus determine the two positions x₂′ and x_{2″}, at which the capacitance changes ΔC₁ and ΔC₂ occurred. The diameter d of the hole 26 is known, so the position x₂ of the centre of the hole 26 can be determined from x₂, and x_{2″}. The accuracy of the position x₂ can be improved by traversing the hole 26 multiple times and averaging the measurement results, which leads to noise reduction.

The hole 26 may be sealed/covered, for example, with a material which has a different dielectric constant or conductivity than the worktable 2. In order that the worktable 2 acts as an electrode, it is ideally made of metal, while in contrast the hole 26 could be sealed, for instance using an insulator, e.g., a nonconductive plastic. The described position determination method would also work in this way, since when crossing materials having different dielectric constants (or different conductivities), corresponding capacitance jumps will occur.

Instead of recesses such as holes 26, depressions such as grooves can also be used as reference position marks or rather as reference position determination identifiers. Alternatively, slots 25 aligned differently (in the x and y directions) can also be used, as is shown in FIG. 1 in the top right corner of the worktable 2.

FIG. 4 shows a further embodiment of the capacitive, second reference object 22 for position determination/calibration of the pipette tip 5′. For this purpose, two triangular recesses 22 arranged pivoted by 180° relative to one another are used on the worktable 2. Upon moving across these two recesses 22 along the path p₁ in the centre of these triangles, the two sections d_{1,1} and d_{1,2} are of equal length, meaning that the second reference point (x₂, y₂) is located precisely between these two sections d_{1,1} and d_{1,2}. However, if the path is offset from the centre, for instance like the path p₂ in FIG. 4, the two sections d_{2,1} and d_{2,2} have different lengths. Based on the shape and size of the recesses 22 and the ratio d_{2,1}/d_{2,2} of the two sections d_{2,1} and d_{2,2}, the measurement unit 13 can accurately determine the offset and thus the position of the second reference point (x₂, y₂). Moreover, the angle error ε, i.e., a directional deviation of a path (cf. path p₃ in FIG. 4) may be determined from a reference direction r_{Ref}. This angle error ε may be computed based on the geometry of the triangles 22 and the known direction of movement along a straight path.

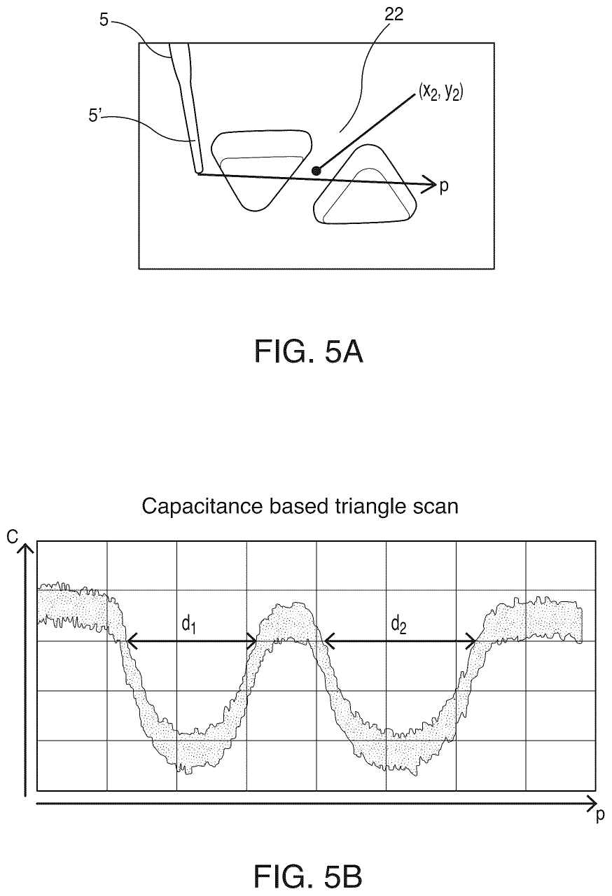

FIG. 5A shows a perspective view of a worktable 2 with a capacitive reference object 22 in the form of two triangular recesses arranged next to each other like in FIG. 4 together with a measuring probe in the form of the pipette tip 5′. The measured capacitance C of the measuring capacitor along the path p of the measuring probe for this capacitive reference object 22 is shown in FIG. 5B. As can be seen from d₁<d₂ the path p is slightly off centre from the second reference position (x₂, y₂).

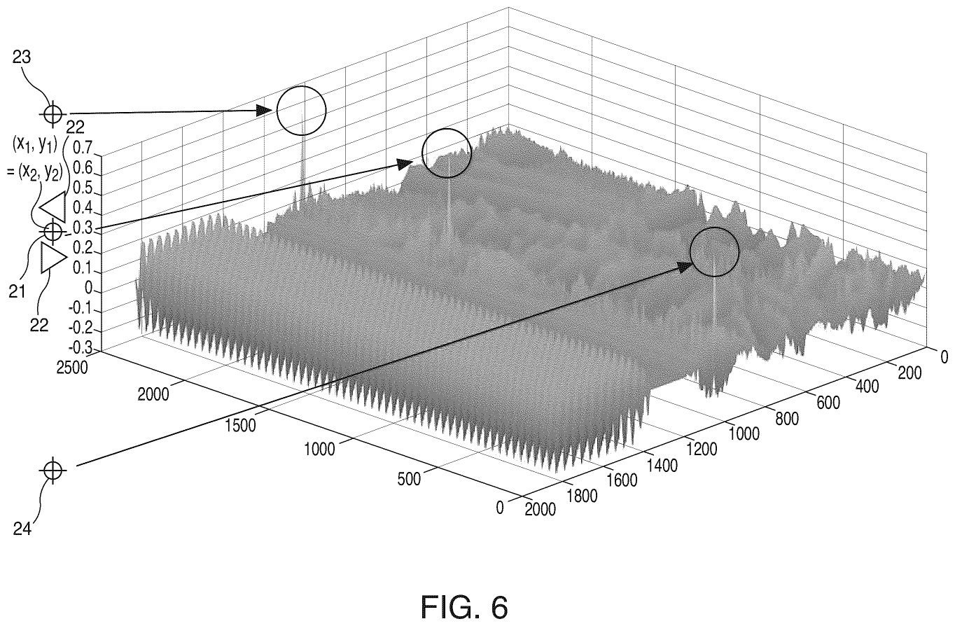

Finally, FIG. 6 shows an exemplary plot of a two-dimensional cross-correlation of an image taken with the camera with a template comprising the crosshairs of the first, third and fourth optical reference objects 21, 23 & 24 for determining their location within the image. The positions of the three crosshairs 21, 23 & 24 are clearly apparent from the three distinct peaks in the 2D cross-correlation plot shown in FIG. 6.

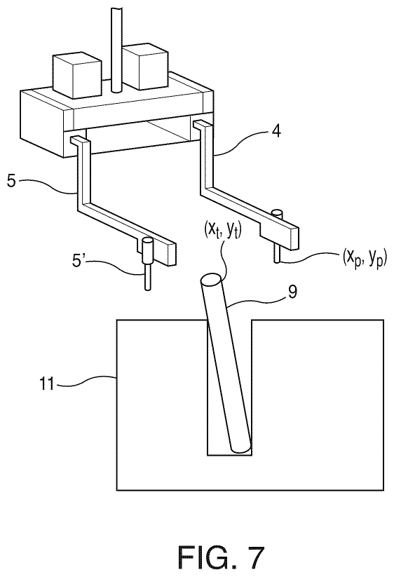

FIG. 7 illustrates another scenario where the method according to the present invention may be employed. FIG. 7 shows a perspective view of a robot arm 4 with a gripper 5 having two fingers, which are to be precisely positioned at opposite sides of a sample tube 9 arranged in a sample tube carrier 11, so that the gripper 5 can accurately and carefully take hold of the sample tube 9 to remove it from the recess within the sample tube carrier 11. The sample tube 9 is arranged atilt in the recess, due to the diameter of the recess being larger than that of the sample tube 9. The target position (xₜ, yₜ) is determined based on an image taken by a camera of the target object, i.e., the opening of the sample tube 9. The opening can be extracted from the image by means of feature extraction. In order to accurately position the gripper 5 at the carrier 11, the carrier 11 features both an optical, first reference object as well as a capacitive, second reference object (both not shown in FIG. 7). The first and second reference objects are preferably collocated at a position on the carrier. This position can be determined from an image of the carrier 11, whereby the image for instance includes the gripper 5 or alternatively the position of the gripper 5 relative to the camera that takes the image is known. To precisely determine the position of the fingers of the gripper 5, a pin 5′ is attached to each finger of the gripper 5. These pins act measuring probes allowing to determine their exact position relative to the capacitive, second reference object by means of capacitance measurements as described in detail above.

Complex targets such as biological samples, e.g., tissue sections/slices, with non-teachable positions (e.g., where the target position varies from one sample to another) can also be integrated into workflows of a sample handling/processing platform by using the proposed method to position an (extraction) nozzle precisely within an area of interest on a tissue slice or a bacteria culture, in particular for so-called colony picking of bacteria cultures or nucleic acid extraction from tissue slices.

A procedure for processing a tissue slice could then essentially be as follows:
Take an image with the camera of the tissue slice;
automatically identify an “area of interest” (e.g., a portion of the tissue slice from which DNA is to be extracted), e.g., based on a manually introduced marking, such as a highlighted contour, or a distinct feature of the tissue slice, by means of image processing, in particular feature extraction;
determine an optimal position (and orientation) of an extractor pod such that an extraction area (e.g., an opening of an extraction nozzle) of the extraction pod, e.g., a circular area, maximally overlaps with the region of interest;
determine a target position (xₜ, yₜ) within the area of interest based on the determined optimal position (and orientation) of the extractor pod;
pick up the corresponding extractor pod;
determine the precise current position (xₚ, yₚ) of the extractor pod attached to the robotic manipulator, in particular the extraction nozzle, based on electrical impedance measurements (as described above);
move the extractor pod from the current position (xₚ, yₚ) to the target position (xₜ, yₜ); and
extract a sample of the tissue slice from the area of interest.

Alternatively, a desired target position (x_{t′}, y_{t′}) could be predetermined on a “template” tissue slice having a contour in common with the tissue slice(s) to be processed. The position (and orientation) offset of the tissue slice to be processed relative to the template could then be determined. The target position (xₜ, yₜ) on the tissue slice to be processed can then be determined based on the position (and orientation) offset and the desired target position (xₜ., y_{t′}) on the template.

Along the same lines, a nozzle can be precisely positioned for 3D printing a structure by dispensing 3D printing material with the nozzle, for instance for tissue extraction in an area of interest, in particular by 3D printing, e.g., with paraffin, a boundary around the area of interest to be extracted.

### LIST OF REFERENCE SYMBOLS

1 automatic sample handling system/device
2 worksurface/worktable
3 sample container(s) (for receiving samples)
4 pipetting robot (arm) movable in x, y & z direction; robot arm with gripper
4′ beam of pipetting robot (movable in x direction) to which z rod (movable in y direction) is attached to which the pipette tip/nozzle (movable in z direction) is attached
5 pipette with pipette tip/nozzle; gripper with finger(s)/pin(s) acting as measuring probe
5′ (disposable) pipette tip; finger(s)/pin(s) of the gripper acting as measuring probe
6 camera
7 sample carrier, e.g., glass slide (Petri dish)
8 microplate
8′ cavity/well in the microplate
9 sample tube in sample tube carrier/rack
10 microfluidic chip
11 sample container carrier/tablet/tray
12′, 12″ first and second edge of hole (second, capacitive reference object)
13 measuring unit
14 control unit
21 crosshair as optical, first reference object
22 triangular recesses as capacitive, second reference object
23 crosshair as optical, third reference object
24 crosshair as optical, fourth reference object
25 cross-slots as capacitive, second reference object
26 recess/hole as capacitive, second reference object
C capacitance of the measuring capacitor
ΔC1, ΔC2 change of capacitance of measuring capacitor
d, d_{i,j} diameter/distance
ε angle error/directional deviation of a path from a reference direction r_{Ref}
p₁, p₂, p₃ travel paths of measuring probe (pipette tip)
R row of optical reference points
r_{Ref} reference direction
(x₁, y₁) first position/coordinates of first reference
(x₂, y₂) second position/coordinates of second reference
(xₚ, yₚ) pipette tip/nozzle opening/pin tip position/coord., optionally also including the z coord. zₚ
(xₜ, yₜ) target position/coordinates
x_{2′} x position/coord. of first edge of recess/hole
x_{2″} x position/coord. of second edge of recess/hole
x first horizontal direction/axis
y second horizontal direction/axis
z vertical direction/axis

What is claimed is:

1. A method for accurately positioning a robotic manipulator or a part (5) attached thereto at a target position (xₜ, yₜ) of a target object (8′) in an automated sample handling device (1), the method comprising the steps of:
providing a worksurface (2) for placement of at least one container (3) and/or container carrier (11), wherein the worksurface (2) extends in a horizontal x and a horizontal y direction;
providing a robotic manipulator, wherein the robotic manipulator is moveable in the x direction, the y direction and a vertical z direction, and wherein at least a part of the robotic manipulator or of the part (5) attached thereto forms a first electrode of a measuring capacitor and thus acts as a measuring probe (5, 5′);
providing an optical, first reference object (21) or mark at a first position (x₁, y₁) at or on the worksurface (2) or container carrier (11), wherein the first reference object (21) is detectable by imaging;
providing a capacitive, second reference object (22, 25) at a second position (x₂, y₂) at or on the worksurface (2) or container carrier (11), wherein the second reference object (22, 25) forms a second electrode of the measuring capacitor, and wherein a position (xₚ, yₚ) of the robotic manipulator or of the part (5) attached thereto relative to the second position (x₂, y₂) is detectable by electrical impedance measurements;
placing a container (3) on the worksurface (2) or container carrier (11), wherein the container (3) or sample carrier (7) features the target object (8′);
capturing at least one image with an imaging device, wherein the at least one image comprises the first reference object (21) and the target object (8′), and wherein the imaging device is mounted on the robotic manipulator;
detecting an imaged first position (x₁′, y₁′) of the first reference object (21) and an imaged target position (xₜ′, yₜ′) of the target object (8′) based on the at least one image;
determining a target position (xₜ, yₜ) based on the first position (x₁, y₁), the imaged first position (x₁′, y₁′) and the imaged target position (xₜ′, yₜ′);
moving the robotic manipulator or the part (5) attached thereto to different locations of the second reference object (22, 25) in a vicinity of the second position (x₂, y₂) and performing an electrical impedance measurement of the measuring capacitor at the different locations of the second reference object (22, 25);
determining a current position (xₚ, yₚ) of the robotic manipulator or of the part (5) attached thereto based on the electrical impedance measurements taken at the different locations of the second reference object (22, 25); and
moving the robotic manipulator or the part (5) attached thereto from the current position (xₚ, yₚ) to the target position (xₜ, yₜ).

2. The method of claim 1, wherein the part (5) attached to the robotic manipulator is at least one of:
a pipette (5) with a pipette tip (5′) or a nozzle, wherein an opening of the pipette tip (5′) or nozzle is to be positioned accurately; and
a gripper (5) with a finger or pin (5′), wherein an end of the finger or pin (5′) is to be positioned accurately.

3. The method of claim 1, wherein the second reference object (22, 25) has at least one edge, at which, during a movement of the measuring probe (5, 5′), the impedance of the measuring capacitor changes, and at which a change of a conductivity or dielectric constant takes place.

4. The method of claim 1, wherein the second reference object (22, 25) comprises at least one material transition, which, during movement of the measuring probe (5, 5′), causes a change of the impedance of the measuring capacitor, and at which a change of a conductivity or dielectric constant takes place.

5. The method of claim 1, wherein the second reference object (22, 25) has at least one recess, depression cut-out or opening, which, during movement of the measuring probe (5, 5′), causes a change of the impedance of the measuring capacitor.

6. The method of claim 5, wherein the recess, depression, cut-out or opening is triangular or trapezoidal, and wherein the second reference object (22, 25) has two identical triangular or trapezoidal recesses, depressions, cut-outs or openings, which are arranged rotated by 180° in relation to one another, and wherein the measuring probe (5, 5′) traverses both recesses, depressions, cut-outs or openings during the measurements.

7. The method of claim 5, wherein the second reference object (22, 25) comprises two slots intersecting each other.

8. The method of claim 1, wherein the first reference object (22, 25) has a distinct shape and/or structure and/or colour.

9. The method of claim 8, wherein the first reference object (22) comprises crosshairs and a circle centred at an intersection of the crosshairs, the intersection being located at the first position (x₁, y₁).

10. The method of claim 1, wherein the first (21) and second (22, 25) reference objects are co-located.

11. The method of claim 10, wherein an optically visible shape or structure of the second reference object (22, 25) acts as the first reference object (21).

12. The method of claim 1, wherein a third and optionally a fourth reference object (23, 24) or mark at a third position (x₃, y₃) and fourth position (x₄, y₄), respectively, are provided at or on the worksurface (2) or container carrier (11), wherein the third and fourth reference object (23, 24) is detectable by imaging.

13. The method of claim 12, wherein the first and third and optionally the fourth reference objects (21, 23, 24) or marks are used to calculate a conversion factor from pixels on the at least one image to millimetres on the worksurface (2).

14. The method of claim 1, wherein the first, third and fourth reference objects (21, 23, 24) are level with the target object and the target object is the same, wherein the first, third and fourth reference objects and the target object are in the focal plane of the imaging device.

15. The method of claim 1, wherein as part of detecting the imaged first position (x₁′, y₁′) of the first reference object a cross-correlation is performed using a template corresponding to the first reference object.

16. The method of claim 1, further comprising:
loading microfluidic chips using a pipette tip (5′) or a nozzle;
integrating targets with non-teachable positions in a sample or liquid handling platform for automating integrated workflows;
positioning a nozzle precisely in an area of interest on a tissue slice or a bacteria culture;
positioning a nozzle precisely when 3D printing a structure by dispensing 3D printing material with the nozzle; or
positioning a gripper (5) of a robotic manipulator precisely at a piece of labware, so that the gripper (5) can accurately take hold of the piece of labware.

17. An automated sample handling device capable of accurately positioning a robotic manipulator or a part (5) attached thereto at a target position (xₜ, yₜ) of a target object, the device comprising:
a worksurface (2) for placement of at least one container (3) adapted to contain, bear or receive one or more samples, and/or of at least one container carrier (11), wherein the worksurface (2) extends in a horizontal x and a horizontal y direction, and wherein the container (3) or sample features the target object (8′);
a robotic manipulator, wherein the robotic manipulator is moveable in the x direction, the y direction and a vertical z direction, and wherein at least a part of the robotic manipulator or of the part (5) attached thereto forms a first electrode of a measuring capacitor and thus adapted to act as a measuring probe (5, 5′);
an optical, first reference object (21) or mark at a first position (x₁, y₁) at or on the worksurface (2) or container carrier (11), wherein the first reference object (21) is detectable by imaging;
a capacitive, second reference object (22, 25) at a second position (x₂, y₂) at or on the worksurface (2) or container carrier (11), wherein the second reference object (22, 25) forms a second electrode of the measuring capacitor, and wherein a position of the robotic manipulator or of the part (5) attached thereto relative to the second position (x₂, y₂) is detectable by electrical impedance measurements;
an imaging device adapted to capture at least one image comprising the first reference object (21) and the target object (8′) and thus acquire an imaged first position (x₁′, y₁′) and an imaged target position (xₜ′, yₜ′);
a measuring unit (13), to which the measuring probe (5, 5′) and the second reference object (22, 25) are operationally connected, adapted to measure an impedance; and
a control unit (14) adapted to:
determine a target position (xₜ, yₜ) based on the first position (x₁, y₁), the imaged first position (x₁′, y₁′) and the imaged target position (xₜ′, yₜ′);
actuate the robotic manipulator such that the measuring probe (5, 5′) is moved to different locations of the second reference object (22, 25) in a vicinity of the second position (x₂, y₂);
trigger the measuring unit (13) to perform electrical impedance measurements at the different locations of the second reference object (22, 25);
determine a current position (xₒ, yₒ) of the measuring probe (5, 5′) based on the electrical impedance measurements taken at the different locations of the second reference object (22, 25); and
move the robotic manipulator or the part (5) attached thereto from the current position (xₒ, yₒ) to the target position (xₜ, yₜ).
